(19) United States
(12) Patent Application Publication
(10) Pub. No.: US 2002/0090089 A1
(43) Pub. Date: Jul. 11, 2002

(54) Methods and apparatus for secure wireless networking

(76) Inventors: Steven Branigan, Tinton Falls, NJ (US); William Roberts Cheswick, Bernardsville, NJ (US)

Correspondence Address: Peter H. Priest, Law Offices of Peter H. Priest, PLLC, 529 Dogwood Drive, Chapel Hill, NC, 27516, US

(21) Appl. No.: 09/755,470

(22) Filed: Jan. 5, 2001

(51) Int. Cl. H04L 9/00

(52) U.S. Cl. 380/270; 713/171

(57) ABSTRACT

Techniques for secure connections between wireless network clients and wired network resources are described. An insecure wireless network comprising a plurality of wireless access points provides a connection for wireless network clients to a wired network server which in turn provides controlled access to a wired network. When a wireless network user wishes to connect to the wired network, the user provides authentication information to the wired network server through the wireless network client and the wireless network access point. Once the wired network server has verified the authentication information, the wired network server provides the wireless network client with a temporary wired network address as well as a unique session encryption key, which is used to encrypt all data transferred between the wireless network client and the wired network server during a connection session.

### FIELD OF THE INVENTION

The present invention relates generally to improvements in wireless network security. More particularly, the invention relates to the use of a wireless network to connect wireless clients to a wired network using an authenticating server which authenticates users for connection to the wired network.

### BACKGROUND OF THE INVENTION

Wireless data networking is becoming more popular as wireless data transfer rates continue to increase. Wireless networking presents great convenience for users in allowing them to connect to the network without having to limit their mobility by the need to have access to a wired connection. The data transfer performance provided by present day wireless communication devices is acceptable for many applications and the increased speeds which can be expected as new devices are developed will make wireless connections suitable for more and more applications. As developing technology allows greater transfer rates, the increased transfer rates, combined with the inherent convenience and ease of use of a wireless connection, will greatly increase the prevalence of wireless networks.

However, wireless networking presents security problems which are not typically found in wired networks. Physical access to a wired network can be controlled by controlling access to the wires connected to the network. Every network connection point can be physically identified and can be controlled and monitored, and the extent of the network can be precisely known by mapping the wiring and connection points. It is much more difficult to control access to a wireless network. Connections to a wireless network occur across three dimensional space and the precise boundaries within which an acceptable wireless connection can be made are difficult to identify. Defining the boundaries within which eavesdropping can occur is even more difficult, because an eavesdropper does not need a perfect transmission and need not necessarily understand all data transmitted in order to gain enough information to seriously compromise confidential data. Wireless networking hardware providers attempt to address the security issues through constructs which limit access to the wireless network or provide security through end to end encryption. A typical prior art wireless network employs a plurality of wireless base stations, each using a single encryption key to secure transmissions to and from clients communicating with that base station. All users communicating with a base station must share the encryption key used by the base station. This presents security problems as users leave the network. In order to maintain good security, all keys which may be known to a user need to be changed whenever a user leaves a network. In the case of a shared key, this requires that all client devices which used the previous key be provided with the new key. Moreover, users of a wireless network are likely to move between base stations. Wireless networking is intended to provide mobility and convenience for users, and a network covering a significant area and employing a number of base stations is likely to be designed to provide connectivity to users without regard to their location, and without requiring them to be within range of a single designated base station in order to establish a connection.

Because a user can communicate with more than one base station, the user needs to have encryption keys for each base station for which a connection is to be established. If a user attempts to connect to a base station and does not have a key for that base station, the connection will fail. It is not convenient for a user to have a connection rejected because he or she moves from a first base station to a second base station without having a key for the second base station. In order to prevent such situations, wireless networks often use one key for all base stations, with the key shared by all users. When the network is first deployed, this arrangement provides acceptable security, but as users leave the system security tends to degrade. Good security practices require that all keys and passwords known to a user be changed whenever that user leaves the network, but it is difficult to enforce this practice if it means that new keys must be generated and distributed to all users on the network whenever a user leaves the system. Maintaining different keys for each base station does not solve the problem, particularly if all users may use all base stations at different times. In that case, each user must be provided with the key used by each base station, and when a user leaves the network, each base station's key must be changed and the new keys must be distributed to all users. Commonly, keys are not changed and as time passes the population of potential unauthorized users possessing encryption keys becomes larger and larger.

Furthermore, wireless network passwords tend to be few in number and shared by all users or a large group of users. Sharing of passwords presents many of the same problems as does sharing of encryption keys.

Moreover, wireless data networking components may themselves be subject to attack. Wireless data networking is relatively new and the encryption techniques employed by wireless data networks have not yet been tested as thoroughly as those used by wired networks. Unknown weaknesses may therefore exist in the encryption used by a particular wireless networking component or group of components.

There exists, therefore, a need for a system which allows wireless networking which provides known, reliable security techniques to prevent eavesdropping and other compromises of system integrity, and which employs authentication and security protocols which allow each user to be assigned a unique password and encryption key each having a status independent of the passwords and encryption keys of other users.

### SUMMARY OF THE INVENTION

Among its several aspects, a network according to the present invention includes a wireless network providing connectivity to client stations with improved security. Depending on design, the wireless network comprises a single wireless access point or alternatively a plurality of wireless access points connected to a central hub. The wireless network provides communication between the wireless access points and the client stations, but does not perform any authentication to control connection to the wireless access points. The wireless network access point provides a connection to a Security Base (SB) server which controls access to the wired network by clients on the wireless network. The SB server has an interface attached to the wireless network, as well as an interface to the wired network. The SB server is typically connected to a network hub on the wired network and acts as a gateway to wired network resources for clients on the wireless network. When a wireless network client establishes a connection to the SB, the SB server performs authentication for the wireless network client, typically by authenticating the username and password of the wireless network client using a user database. Once the wireless network client has been authenticated, the SB server provides the wireless network client with a temporary Internet protocol (IP) address on the wired network, using dynamic host control processing (DHCP). The SB server also provides the wireless network client with a unique session key to be used for encrypted communication with the wired network. The session key is used by one client during one connection session to the wired network.

It is not necessary to control access to the wireless network because the wireless network in and of itself does not provide access to anything of value. The wireless network only provides access to the SB server, which will not provide access to wired network resources without authentication and which, moreover, encrypts all information passed to the wireless network. Without authentication, a wireless network client cannot gain access to wired network resources and an eavesdropper cannot gain access to network information because all traffic over the wireless network which contains substantive information from the wired network is encrypted.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a connection between a wireless network and a wired network according to the present invention, with authentication of wireless network users and control of access to the wired network performed by a server according to the present invention, with the wireless network providing a single wireless access point for connection by wireless clients;

FIG. 2 illustrates a connection between a wired network and a wireless network employing connection, encryption and authentication techniques according to the present invention, the wireless network comprising multiple wireless access points; and

FIG. 3 illustrates a process of network authentication and security according to the present invention.

### DETAILED DESCRIPTION

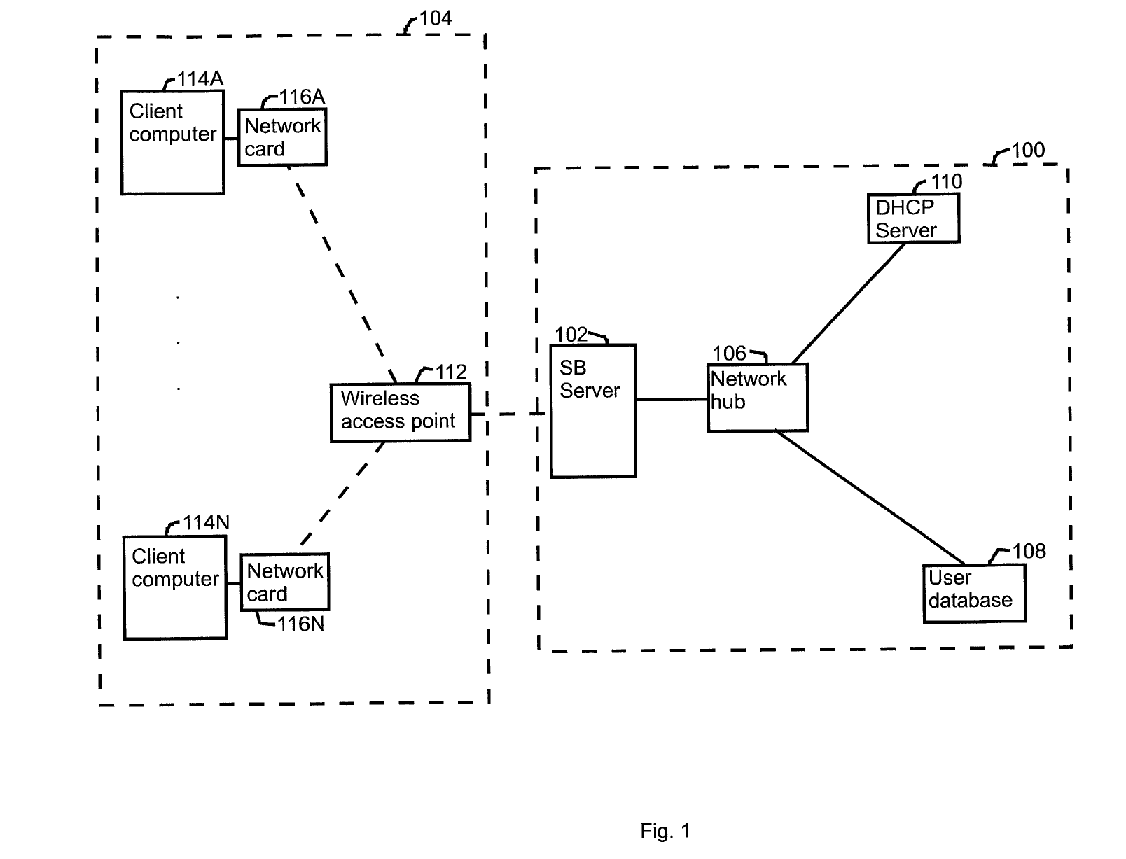

FIG. 1 illustrates a wired network 100 which provides authentication and security to wireless network clients according to the present invention. The wired network 100 includes an SB server 102 according to the present invention, providing a connection between the wired network 100 and a wireless network 104. The SB server 102 controls access to the wired network 100 by the wireless network 104, and provides address and authentication services to clients of the wireless network 104. The wired network 100 also preferably comprises a network hub 106, which provides a connection to additional wired network resources including, but not limited to a user authentication database 108 for use by the SB server 102 in authenticating clients seeking access to the wired network 100 and a DHCP server 110 for providing temporary addresses to authenticated clients of the wired network 100.

The wireless network 104 comprises a wireless network access point 112 providing wireless network connections to network client devices such as laptop computers 114A . . . 114N, each of the computers 114A . . . 114N connecting to the access point 112 using a wireless network card 116A . . . 116N, respectively. In the implementation shown here, the wireless network cards are WAVELAN cards conforming to the IEEE/802.11 networking standard and the client devices 114A . . . 114N have installed point to point tunneling protocol (PPTP) software supporting 128-bit encryption. The use of particular networking cards and the use of PPTP, however, are not essential features of the present invention, and many other implementations may be envisioned, including the use of the LUCENT Virtual Private Network (VPN) Gateway in place of PPTP, or the use of Secure Shell (SSH) in place of PPTP. SSH provides secure File Transfer Protocol (FTP), Telnet and X-Windows access. The use of SSH allows use of the present invention in a UNIX/X-Windows environment.

The SB server 102 is assigned a permanent address on the wireless network 104 in order to allow the wireless devices 114A . . . 114N to connect to the SB server 102 to request authentication for access to the wired network 100. Similarly, the SB server 102 is assigned a permanent address on the wired network 100 in order to provide routing from the wireless network 104 to the wired network 100.

When a user of a device, for example a user of the computer 114A, wishes to connect to the wired network 100 using the wireless network 104, a connection to the wireless access point 112 is established using the wireless network card 116A. Connection and address information for the wireless network 104 can be widely published and disseminated, because the wireless network 104 does not provide access to any resources other than the ability to request the SB server 102 to provide authentication and access to the wired network 100. Initial traffic between the client computer 114A and the SB server 102 is encrypted, preferably using encryption protocols supported by the SB server 102 and the wireless network card 116A. It is also possible, if desired, to perform encryption using the SB server 102 and the client computer 114A, without a need for encryption by the wireless network card 116A. Encryption is done because the client computer 114A will send confidential information such as a username and password to the access point 112 in order to request the SB server 102 to provide authentication and it is important to protect this information from eavesdroppers. Encryption of traffic passing between the computer 114A and the access point 112 may suitably be accomplished using public key cryptography, which makes unnecessary the transferring of secret keys between the client computer 114A or wireless network card 116A and the SB server 102. The wireless network access point 112 does not need to encrypt any data, because encryption and decryption occur at the SB server 102 and the wireless network card 116A card during initial authentication and at the SB server 102 and the wireless network client 114A once authentication has been accomplished.

Once the client computer 114A has been connected to the wireless network access point 112, the access point 112 transfers information between the computer 114A and the SB server 102 using the network protocol employed by the wired network 102 and the wireless network 104. The network protocol used is preferably a virtual private network protocol, and in the exemplary implementation illustrated here is point to point tunneling protocol. A virtual private network is a configuration which allows the use of publicly available facilities to be used to establish a connection between entities (such as clients and servers) which are part of a private network. Virtual private network protocols provide security between entities belonging to the private network, in order to prevent eavesdropping or other compromise of information or resources by persons who have access to the public facilities but who are not authorized users of the private network. An example of a virtual private networking arrangement would be the use by a corporation of the Internet to connect remote network users to the central corporate network. In the exemplary case illustrated here, the use of the wireless network 104 to connect clients to the wired network 100 is a case of virtual private networking, even if the wireless network 104 is provided and maintained by the owner or administrator operating the wired network 100. This is because the wireless network 104 is publicly accessible, in that no effort is made to restrict its use, even if it is not specifically developed as a resource to be offered to the general public. Therefore, virtual private network protocols such as point to point tunneling protocol, are used to protect the information traveling over the wireless network 104, so that security is managed by entities involved in the connection to the wired network 100, such as the client computer 114A, network card 116A and SB server 102, without any need for the wireless network 104 to contribute to maintaining security.

Once the client computer 114A establishes a connection to the SB server 102, the SB server 102 performs authentication. Authentication is preferably performed using the authentication system implemented in Plan 9 from Bell Laboratories, but may suitably be performed according to any desired authentication system, providing that the system provides proper security. The SB server 102 preferably logs each connection attempt, whether or not the connection attempt was successful, in order to allow for later auditing and security analysis. The SB server requests authentication information, typically a username and password. The user provides the username and password, which is transmitted wirelessly to the access point 112 and then communicated to the SB server 102 using a wired connection between the access point 112 and the SB server 100. Once the SB server 102 receives the authentication information, it makes a connection to the user authentication database 108 using the wired network 100 and compares the authentication information received from the client computer 114A against the information contained in the user authentication database 108. If the authentication information received from the client computer 114A does not match the information in the database 108, the SB server 102 rejects the connection attempt. Preferably, the SB server 102 provides the user with a predetermined number of attempts to provide correct authentication information and then, if an excessive number of attempts is made, imposes a delay before a new attempt will be processed. This procedure helps to protect against repeated automated attempts to guess authentication information. The SB server 102 preferably logs each authentication attempt and does not provide any access to resources on the wired network 102 until valid authentication information is received. When valid authentication information is received, the SB server 102 requests an IP address from a DHCP server 110 and furnishes this address to the client computer 114A. The SB server 102 also secures subsequent communications with the client computer 114A, preferably using the Microsoft implementation of RC-4, but may suitably use any desired system for providing communication security. The SB server 102 furnishes an encryption key to the client computer 114A for cryptoprocessing information transferred between the client computer 114A and the SB server 102. Once the key has been furnished to the client computer 114A, neither the client computer 114A nor the SB server 102 will transmit plaintext information to the other during the remainder of the session. Once authentication has been performed and the client computer 114A has been given an address for access to the wired network, the client computer 114A is allowed access to network resources according to the privileges associated with the username used in authentication.

It will be recognized that it is possible for a wired network such as the wired network 100 to be connected to other networks using a router. In such a case, a router may be substituted for the network hub 106 and the SB server may be connected to the router, in order to provide access by wireless network clients to the wired network 100 and the other networks to which the wired network 100 is connected.

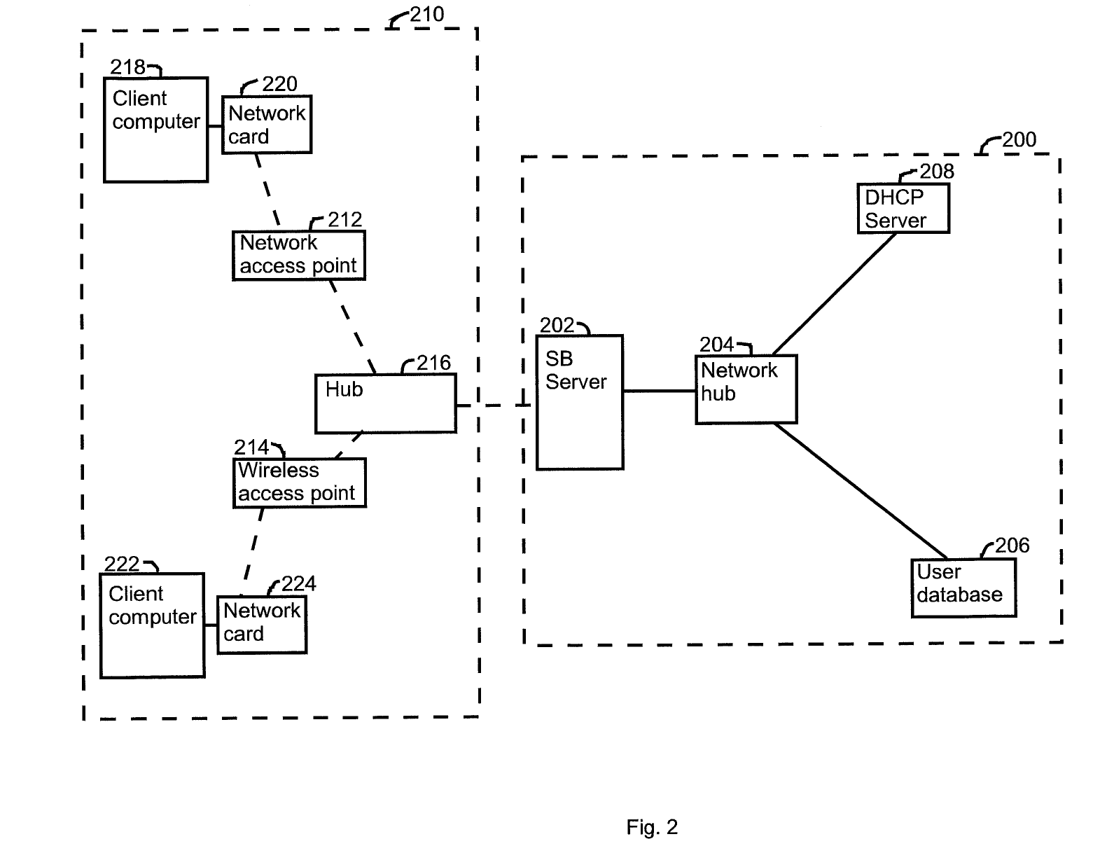

It is also possible to employ an SB server to provide connection to a wireless network comprising a plurality of wireless network access points. Providing a plurality of wireless network access points allows users to “roam” seamlessly from one access point to another. The present invention allows a user to perform authentication one time and receive at authentication a single session encryption key valid at all access points. FIG. 2 illustrates a wired network 200 employing an SB server 202 to provide authentication and security for wireless clients according to the present invention. The wired network 200 also includes a wired network hub 204 and various additional network resources a user database 206 and a DHCP server 208. In cases in which the wired network 200 is connected to other networks using a router, the router may be substituted for the hub 204. The SB server 202 provides connection services to allow clients connected to a wireless network 210 to gain access to network resources using the same protocols described above in connection with FIG. 1. The wireless network 210 comprises two wireless access points 212 and 214 connected to a network hub 216, which is in turn connected to the SB server 202. The wireless access point 212 is connected to a client computer 218 by means of a wireless network card 220 and the wireless access point 214 is connected to a client computer 222 by means of a wireless network card 224. In typical wireless networking arrangements, wireless access points such as the access points 212 and 214 are physically distant and allow multiple access points to the wireless network, each access point being out of radio range of most other access points. For simplicity, the wireless network 210 is shown here as comprising two wireless access points, each connected to a single client computer. However, it will be recognized that the wireless network 210 may include any number of wireless access points, each connected to a plurality of client computers, with the only limitation on the number of wireless access points and the number of client computers connected to each access point being those suggested by sound network management practices. Authentication and communication security are preferably performed as described above in connection with the SB server 102 of FIG. 1.

The use of an SB server to control access to a wired network by a wireless network provides good scaling for any size of wireless network. The number of connections to the wired network scales arithmetically as the size of the wireless network increases, with no more than one connection to the SB server being presented with each addition of a wireless access point to the wireless network. Moreover, the management of passwords and keys is not increased in complexity by the addition of wireless access points. When a user leaves a network such as the wired network 200, his or her authorization to use the wired network 200 can be removed at the user database 206, without any need to make changes at any of the wireless network access points such as the access points 214 and 216 in the case of the wireless network 210, or potentially many more access points in the case of a larger network.

Because the radio footprint of a wireless network such as the network 210 is unknown, it must be assumed that an attacker may have access to the radio transmissions used to transfer data between the elements of the network. The attacker may be able to eavesdrop on wireless network sessions, hijack a session by impersonating a client computer with an already established connection to the network, interrupt a session or initiate a session. However, because the wireless network 210 contains no information or access to resources having value to an attacker, the vulnerability of the wireless network is unimportant. Because the wired network 200 is protected by the SB server 202, which implements a well tested authentication system and uses strong encryption to pass data to the wireless network 210, the vulnerability of the wireless network 210 does not compromise any data or resources in the wired network 200. Traffic analysis of the clients and encrypted sessions are available to an eavesdropper, because the communications are radiated over a footprint of unknown size. However, the use of PPTP encapsulates the network traffic, causing all traffic to have an address tuple of the client system and the SB server 202. Traffic analysis, therefore, will not yield the addresses of the SB server and the client computers such as the computer 218.

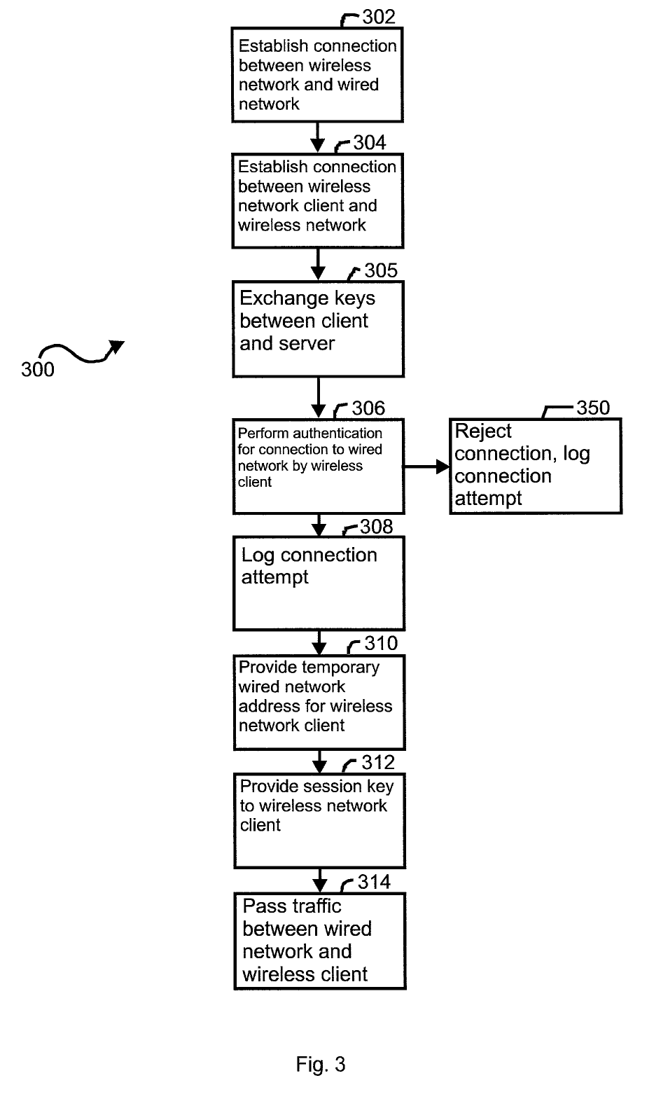

FIG. 3 illustrates a process 300 of authenticating and securing a connection between a wireless network client and a wired network according to the present invention. At step 302, a connection is established between a wired network and a wireless network. The wireless network may suitably be similar to the wireless network 104 of FIG. 1 and the wired network may suitably be similar to the wired network 100 of FIG. 1. Connection may suitably be established between the wired network and the wireless network by establishing a connection between an SB server similar to the SB server 102 of FIG. 1 and a wireless network access point similar to the access point 118 of FIG. 1. At step 304, a connection is established between a wireless network client and the wireless network, suitably by establishing a connection between the wireless network client and the wireless network access point. The wireless network client may suitably be similar to the computer 114A of FIG. 1, and may suitably communicate with the access point with a wireless network card similar to the network card 116A of FIG. 1. At step 305, in response to a request to establish a connection between the wireless network client and the wired network, encryption keys are exchanged between the wireless network client and the server in order to protect data to be used for authentication. Next, at step 306, authentication is performed for the wireless network client, suitably by requesting and receiving a username and password and comparing the username and password against a user database. The information exchanged between the server and the client is encrypted using the keys exchanged at step 305. If authentication fails, the process proceeds to step 350, the connection is rejected and the connection attempt is logged. If authentication passes, the process proceeds to step 308 and the connection attempt is logged. Next, at step 310, the wireless network client is provided with a temporary address on the wired network, preferably using DHCP. At step 312, a unique session encryption key for use in communicating with the wired network. At step 314, traffic is passed between the wireless network client and the wired network through the SB server, with access to network resources being given to the client in accordance with the user privileges associated with the account information provided for authentication.

While the present invention is disclosed in the context of a presently preferred embodiment, it will be recognized that a wide variety of implementations may be employed by persons of ordinary skill in the art consistent with the above discussion and the claims which follow below.

We claim:

1. A wired network for providing secure, authenticated access to wireless network clients, comprising:
a server connected to a wireless network access point, the server being operative to perform authentication for wireless clients establishing a connection to the server through the wireless network access point, the server being operative to establish a connection session upon authentication of a client, the server being also operative to provide the client with a wired network address valid for the connection session upon authentication of the client, the server being further operative to encrypt communications with the wireless network access point, the server being further operative to provide a cryptographic key valid for the connection session to the client upon authentication of the client; and
a user database accessible to the server for use in validating wireless clients.

2. The wired network according to claim 1 and also including a network hub providing connections between the server and additional resources on the wired network.

3. The wired network according to claim 1 and also including a router providing connections between the server and additional resources on the wired network as well as a connection to an additional wired network.

4. The wired network according to claim 2 wherein the server is operative to provide addresses to clients through dynamic host control protocol.

5. The wired network according to claim 4 wherein the server is operative to communicate with a wireless network client using point to point tunneling protocol.

6. The wired network according to claim 5 wherein the server employs 128-bit cryptoprocessing to communicate with the wireless network client.

7. A wireless network for providing secure authenticated communication between clients of the wireless network and a wired network, comprising:
a wireless network access point operative to establish a connection with a server operating as a portal between the wireless network and a wired network, the wireless network access point being operative to conduct communications with the server, the wireless network access point being further operative to receive authentication information from clients and transfer the authentication information to the server and to receive a cryptoprocessing key from the server and transfer the key to each of the clients; and
a plurality of wireless network clients operative to establish connections with the wireless network access point, each client being operative to conduct encrypted communications with the server through the access point, to pass authentication information to the network access point and receive address information and cryptoprocessing data from the network access point to allow communication with the wired network, each client being operative to conduct encrypted transfer of data to and from the wired network through the access point upon receiving the address and cryptoprocessing information.

8. The wireless network of claim 7 wherein the access point communicates with the server using point to point tunneling protocol.

9. The wireless network of claim 8, also including a hub connecting the wireless network access point and a plurality of additional network access points, each additional network access point communicating with a plurality of additional wireless network clients, the wireless network access point and the additional network access points being operative to establish connections with the server through the network hub.

10. A method of secure communication between wireless network clients and a wired network, comprising the steps of:
establishing a connection between an SB server connected to the wired network and a wireless network access point;
establishing a connection between the SB server and a network client communicating with the SB server through the wireless network access point;
exchanging encryption keys between the SB server and the wireless network client;
performing authentication for the wireless network client;
if authentication fails, rejecting connection to the wired network; and
if authentication passes, accepting connection to the wired network, providing a temporary wired network address and a unique session encryption key to the wireless network client and providing access to wired network resources in response to requests by the wireless network client.

11. The method of claim 10 wherein the step of rejecting connection to the wired network is accompanied by a step of logging the rejection and wherein the step of accepting the connection is accompanied by a step of logging the acceptance.

12. The method of claim 11 wherein the step of providing a temporary wired network address to the wireless network client includes using dynamic host control protocol to provide the address.

13. The method of claim 12 wherein communication between the wireless network client and the wired network server is performed using point to point tunneling protocol.

14. The method of claim 13 wherein the step of performing authentication for the wireless network client includes transferring authentication information between the wireless network client and the SB server and wherein the authentication information is encrypted using public key cryptography.

15. The method of claim 14 wherein the step of providing a unique session encryption key includes encrypting the unique session encryption key using public key cryptography.
